(19) United States
(12) Patent Application Publication
(10) Pub. No.: US 2009/0024702 A1
(43) Pub. Date: Jan. 22, 2009

(54) Method for Selection and Display of at Least One Piece of Additional Information

(76) Inventor: René Schweier, Stuttgart (DE)

Correspondence Address: DREISS, FUHLENDORF, STEIMLE & BECKER, POSTFACH 10 37 62, D-70032 STUTTGART, DE

(21) Appl. No.: 12/223,396

(22) PCT Filed: Feb. 1, 2007
(86) PCT No.: PCT/EP2007/000865

§ 371 Date: Jul. 30, 2008

(30) Foreign Application Priority Data
Feb. 3, 2006 (EP) 06002210.0

(51) Int. Cl. G06F 15/16

(52) U.S. Cl. 709/203

(57) ABSTRACT

The selection and display of a piece of information, in addition to other information which may be transmitted from a server (3) to a client (2), may be improved such that a reduction in the load on the communication network is possible, by means of automatic analysis of a profile assigned to the user (7) of the client (2), wherein at least one piece of partial information is automatically selected from the information depending on the result of the analysis of the profile, one piece of additional information is automatically selected from the available additional information depending on the analysis of at least one property of the partial information, an activation element which may be activated is automatically assigned to the partial information, wherein, on activation of the activation element, an action assigned to the additional information is automatically carried out and the activation element is automatically provided with a representation element, by means of which at least one parameter relating to the representation of the activation element on the client (2) may be set.

The invention relates to a method for selection and display of at least one piece of additional information depending on information items to be transmitted or already transmitted from a server to a client across a communication network.

The invention also relates to a client-server system, comprising a client assigned to a user and connectable with a communication network and a server connectable with a communication network.

The invention furthermore relates to a computer program that runs on at least one component of a client-server system.

The term server denotes an element, for example, a component of a communication network that provides certain services. Such services exist, in particular, in the provision of information items that can be requested from a server that is, for example, also a component of a communication network. A server can, for example, be an information portal connected to the so-called Internet, from which information items can be requested using a client in the form of a personal computer, PDA (personal digital assistant) or smartphone. In response to an information request, the server causes transmission to the client of the requested information, for example, in the form of a so-called network page or Web page across the communication network.

Within the multimedia information system constituted by the Internet and termed World Wide Web (WWW), network pages can be addressed by means of so-called URLs (uniform resource locators). A URL comprises, among other elements, the name of the server providing the network page, an (at least virtual) directory and a name assigned to the network page. A URL makes it possible to request the network page assigned to this URL by means of a client by selecting the URL. Within the WWW, the information contained in a network page is described, for example, by means of the standardized page description language HTML (Hypertext Mark-Up Language) or a language derived from it (e.g. WHTML, XHTML).

There are many further ways of transmitting information from a server to a client. Well-known examples include electronic mail (e-mail) or the transmission of information in the form of an SMS (Short Message Service). Information can also be transmitted from a server to a client in the form of a data stream. A data stream can, for example, be a radio program transmitted across the communication network, such as the so-called Internet radio, or a television program transmittable across the communication network, which is transmitted from the server to the client in the form of a data stream comprising video information.

Information can also be transmitted in the form of files from a server to a client, for example, by means of the so-called file transfer protocol (FTP) or, for example, as a so-called attachment to an e-mail.

It is known that a certain set of information, for example, the information that can be transmitted by means of a requested network page, can be provided with a piece of additional information. A piece of additional information can be any type of information that is transmitted to the client, but was not explicitly requested by the client. An especially well-known implementation of additional information is displayed to a user of a client in the form of a so-called advertising banner. An advertising banner permits the display of an advertising message, for example, in the form of a textual and graphical representation.

The server can, for example, be implemented as a so-called search engine. A search engine is a server connected to the communication network, to which a user of a client transmits a request in the form of a search term by means of the client. The search engine determines information that is associated with the search term based on definable rules depending on the search term. The search engine causes the information determined in this way, called the search result, to be transmitted to the client by means of a network page. For transmission of the information, for example, an HTML document is dynamically generated by the server, transmitted to the client, and displayed to the user by means of a software element, for example, a so-called browser. Frequently, pieces of additional information are added to such information in the form of advertising banners that are displayed to the user viewing the transmitted network page.

The server can, for example, also provide the contents of a newspaper or magazine for retrieval. If a user requests information representing an article by means of a client, it is known that, for example, pieces of additional information can be transmitted to the client in a separate column. Such pieces of additional information may, for example, be advertising messages describing the terms for subscription or addresses of further reference information.

The server can also be constituted as a so-called online shop. An online shop allows the user to receive information about a product by means of a client and to order or purchase this product through the online shop. In this case, too, it is known that pieces of additional information can be assigned to the requested information, for example, in the form of suggestions for purchasing further products or in the form of technical details, and be transmitted to the client.

The server can also be constituted as an e-mail server that transmits an e-mail to a client. In this case, too, it is known that pieces of additional information can be added to an e-mail concerning, for example, particularly up-to-date news.

Because of the large volume of information provided, for example, over the Internet, it is now common that a certain piece of information can only be located by interposing one or more search engines. For this purpose, multiple requests to the search engine and multiple transmissions of result lists to the client are usually necessary.

Overall, the quantity of information transmitted between servers and clients has grown rapidly since the creation of such communication networks and will continue to grow rapidly because an increasing quantity of information is transmitted across communication networks. Different techniques are used to cope with the constantly increasing requirement for information by users or clients assigned to these users. Communication networks with increased bandwidths are set up and deployed or existing communication networks are expanded. One example from the field of mobile telecommunications is the development of so-called UMTS (Universal Mobile Telecommunications System), which is currently replacing the less powerful GSM (Global System for Mobile Telecommunications).

Moreover, compression algorithms are being developed and deployed that reduce the quantities of data representing the information that has to be transmitted across the communication networks.

Basically, in particular pieces of additional information have the potential to reduce the quantity of data to be transmitted across a communication network because a user of a client or a client does not have to request this information itself.

In this case, the transmission of pieces of additional information can, in particular, result in a reduction of the total information to be transmitted across the communication network if the pieces of additional information are of great relevance to the user.

Frequently, however, a piece of additional information is regarded as unpleasant by the user, in particular, if the piece of additional information is not relevant to the user.

It is the object of this invention to create a way of selecting maximally relevant pieces of additional information and representing them in such a way that they are regarded as minimally objectionable by a user of the client.

The object is achieved by a method of the type stated in the introduction by which
a profile assigned to the client or a profile assigned to a user of the client is automatically analyzed,
depending on the analysis of the profile, at least one piece of partial information is automatically selected from the information,
a piece of additional information from a definable set of pieces of additional information is automatically selected depending on the analysis of at least one criterion,
an activation element that can be activated is automatically assigned to the piece of partial information wherein, if the activation element is indeed activated, an action assigned to the piece of additional information is performed automatically, and
a display element is automatically assigned to the activation element, by means of which at least one parameter can be defined concerning display of the activation element on the client.

A profile assigned to the client or to the user comprises, for example, personal data of the user, such as his or her age or special fields of interest. By analysis of this profile, within the information requested or to be transmitted, for example, within the network page to be transmitted, it is possible to select a certain piece of partial information, for example, a certain word, a section describing a certain topic or image information describing a product.

In particular, the piece of partial information can also be a search term, by which the user has searched in a search engine by means of the client at a previous time. In this case, this search term, also termed a keyword, can be stored, for example, as profile information in the profile assigned to the client or to the user of the client.

According to the inventive method, a piece of additional information is also selected from a definable set of pieces of additional information. The set of pieces of additional information can, for example, be stored in a database on the server. It is also possible for the set of pieces of additional information to be retrievable from one or more further servers. For selection of the piece of additional information, at least one property of the selected piece of partial information is analyzed. A property can, for example, be a subject area that is defined by the piece of partial information. It is then possible, in particular, to select a piece of additional information belonging to the same subject area.

An activation element that can be activated is automatically assigned to the piece of partial information. Activation of the activation element causes an action assigned to the piece of additional information to be performed. Such an action may, for example, be a request for further information.

The piece of additional information can, in particular, itself have a link assigned to it, so that the piece of additional information can be retrieved from the server or another server, for example, in the form of a network page or an executable script. In this case, the activation element can be represented by means of a link so that the action defined by the activation element can be to request this piece of additional information or execute the script.

A display element is automatically assigned to the activation element. By means of the display element, at least one parameter is defined concerning display of the activation element on the client. If the activation element is, for example, a link to the piece of additional information, it can be defined by means of the display element that the link will be displayed by highlighting the piece of partial information, for example, by underlining or placing a border around the piece of partial information.

The activation element and the display element therefore describe, in particular, functionalities that describe both display of the activation element, for example, a link, and an action that results in display of the piece of additional information. In particular, the display element can implicitly describe display of the piece of partial information to which the piece of additional information and therefore, in particular, also the activation element is assigned.

The inventive method has the advantage that only those pieces of additional information are displayed that could be of especially great relevance to the user, based on the association with a piece of partial information which, in turn, has been selected based on the profile. Moreover, with the inventive method, it is possible to display the piece of additional information not immediately but only when the activation element has been activated. In this way, the user can decide for himself or herself by activating the activation element whether he or she would like to view or request the additional information.

The information is preferably transmitted across the communication network, in particular, over the Internet in the form of an electronic mail message, an electronic short message service message, a network page or a data stream.

An electronic mail message is, for example, a so-called e-mail that is written by a correspondent or automatically generated by a software element. By means of the inventive method, for example, individual words in the e-mail can be selected depending on the profile assigned to the recipient. The activation element may, for example, be constituted as a link that, on activation, automatically selects a network page assigned to the selected pieces of additional information. By means of the display element, it can be defined, for example, that the word selected as a piece of partial information is displayed in italics, bold, or underlined.

An electronic short message service message is, for example, a so-called SMS (Short Message Service), by which transmission of a text message to a telecommunications terminal, in particular, a mobile telephone is possible.

A data stream can contain text, audio and/or video information. A data stream can, for example, be a TV program that is part of the so-called Internet TV. A piece of partial information in this case could denote, for example, a certain sequence within a data stream. A piece of partial information can also describe, for example, a certain product that is shown in the TV program. For example, an activatable button can be displayed in a definable zone as the activation element to show to the user that pieces of additional information are available about this product.

In an advantageous embodiment of the inventive method, the piece of additional information is only transmitted to the client when the activation element is activated. This has the advantage that the piece of additional information is only transmitted across the communication network to the client when the user actually shows interest in the piece of additional information by activating the activation element. This again reduces data traffic across the communication network.

In a preferred embodiment, the selection of the piece of partial information is performed using a means of selection assigned to the server and information are transmitted to the client together with the activation element. In this case, the means of selection can be the special software element that implements the functionality of selection of the piece of partial information. The means of selection can also be implemented in hardware, for example, by way of a special server that is disposed separately from the server providing information. In this case, of course, a software element implementing selection of the piece of partial information can run on the separate server.

The functionality of selection of the piece of additional information or of selection and/or analysis of the profile can also be performed by an additional information server or profile server. An activation element is then assigned to the piece of partial information and the information prepared in this way is transmitted to the client. This has the advantage that no additional software has to be installed on the client. Rather the greater part of the inventive method can be executed on one or more servers and implementation facilities on the client can be used for displaying the information and the activation element. For example, the activation element can be constituted as a hyperlink that can be displayed and activated using means provided by a browser running on the client.

In a further preferred embodiment, the information is transmitted to the client, selection of the piece of partial information is performed on the client, a property of the selected piece of partial information is transmitted to an additional information server, a piece of additional information is selected by the additional information server, the piece of additional information or at least the existence of a piece of additional information is transmitted to the client and the activation element is displayed on the client. In this embodiment, selection of a piece of partial information is therefore performed on the client. The profile required for this can, for example, be directly present on the client or be requested from a profile server across the communication network. The selected piece of partial information itself or a characteristic, for example, a subject area, is then transmitted from the client to an additional information server. This server selects a matching piece of additional information and transmits the piece of additional information and/or an indication of the existence of the piece of additional information, for example, a URL assigned to the piece of additional information, to the client. There the piece of partial information is provided with the activation element and displayed to the user. The functionality for selection of the piece of partial information can, in this case, be implemented, for example, as a so-called plug-in of the browser.

In a further embodiment, the activation element or the display element is assigned to the piece of partial information on the server. This has the advantage that when the activation element is selected, a property of the selected piece of additional information can be taken into account. If the piece of additional information includes, for example, a very small data volume, the piece of additional information can be transmitted to the client together with the information. Activation of the activation element then results in display of the already transmitted piece of additional information. If the piece of additional information comprises a very large volume of data, for example, because the piece of additional information is implemented in the form of a video clip, an audio clip, an image file or a network page, the activation element can be constituted such that the piece of additional information is not transmitted to the client until activation has been performed.

If the activation element or the display element is assigned to the piece of partial information on the client, this has the advantage that user-specific adaptation of the activation element or the display element is possible. If the user is interested, for example, in numerous pieces of additional information, he or she may choose to always have the piece of additional information transmitted automatically. This can be done by configuring the activation element accordingly. By user-specific adaptation of the display element, the user can, for example, decide whether he or she would like to receive the activation element in the form of a button or by highlighting of the piece of partial information.

Preferably, the piece of partial information is selected depending on one or more of the following criteria:
at least one property of at least one possible piece of additional information,
a position within the information and
a property of the information or a property of a subset of the information, within which the piece of partial information is located.

One property of a possible piece of additional information is always the availability of that piece of additional information. This ensures that display of an activation element does not refer to a piece of additional information that does not actually exist. If the piece of additional information is, for example, a product description, the property can describe both the availability of the product description and, in particular, the availability of the product. The property can also describe a certain subject area or mark an especially topical information item. This can further increase the relevance of the piece of additional information.

Taking into account a position of the piece of partial information within the information to be transmitted or already transmitted can, for example, prevent a piece of additional information from being offered or transmitted about a piece of partial information that is shown in a footnote, because it can be assumed in this case that it is highly improbable that the user will notice this. For example, if the piece of partial information is inside a text much further up, this piece of partial information can be selected in preference.

A property of the information or a subset of the information, within which the piece of partial information is located, can, for example, describe a subject area or a sectional subject area. If, for example, the information refers to topical daily news, it is possible to ensure that only few or no pieces of partial information are selected there. However, if the information is, for example, a result list of a product search engine, it is possible to ensure that numerous pieces of partial information are selected.

If the information represents, for example, a page of an online magazine, it is possible for a piece of partial information to only be selected if it is located within a text section whose topic is the best possible match for the user's interest, with the possibility of deriving the interest from analysis of the profile.

This makes it possible to assign pieces of additional information to certain subject areas and, moreover, only to select pieces of partial information in subject areas of which the user will very probably take notice and where the user will not feel disturbed by the presence of pieces of additional information. Since pieces of partial information are not selected unnecessarily, this both boosts the efficiency of the inventive method and increases the relevance of the displayed pieces of additional information.

It is especially advantageous if the piece of additional information is selected depending on one or more of the following criteria:
analysis of the profile,
evaluation of the piece of additional information available to be selected,
a property assigned to the information, the property describing a content, a subject area, an origin, or a degree of topicality and
an external condition, wherein the external condition describes a current date, a current time of day, a current location of the user, a current location of the client, a temperature, a current trend, or a current event.

By again analyzing the profile for selection of the piece of additional information, a high level of relevance of the piece of additional information can be ensured particularly well. For example, subject areas that are especially interesting to the user or basic interest can be detected in this way. Moreover, with a suitable piece of profile information, for example, it can be determined whether the user is especially interested in pieces of additional technical information, for example, about a product or prefers an offer of a certain online shop. Moreover, for example, certain interests can be inferred from the purchasing habits or the profession and the piece of additional information can be selected accordingly.

The pieces of additional information available for selection can be analyzed, for example, with respect to the type of information—news or product information—the sector, the number of activations (clicks) or degree of topicality.

If the piece of additional information is a piece of additional information concerning a product, the evaluation can, in particular, also describe a sector, a number of sales, leads or conversions and an availability or delivery time. This further increases the usefulness of the pieces of additional information to the user.

A property assigned to the information describes, in particular, a thematic content or subject area, to which, for example, the network page representing the requested information is assigned. Moreover, depending on the origin of the information, for example, the online shop or the publishing house, to which an online magazine is assigned, and therefore, in particular, depending on the server from which the information was requested, it is possible to infer a special interest of the user and thus achieve still greater relevance of the piece of additional information.

In particular, by entering external conditions in the selection of pieces of additional information, it is possible to increase the degree of topicality and therefore the relevance. If the piece of partial information describes, for example, the term “Fitness” and if the information including this piece of partial information is requested in the morning, information about putting together a fitness breakfast menu could be selected. If this piece of partial information is requested in the evening, on the other hand, the piece of additional information could describe a special offer from a fitness club. In particular, if the profile assigned to the user or the client is analyzed, the information offered could be limited to that about a fitness club that is located within a reasonable distance from the user's location.

The piece of additional information is selected depending on at least one property of the selected piece of partial information. Such a property could, for example, describe a type of information—image, video, or text information. The property can also state a position within the information. A property of the piece of partial information can also describe whether the piece of partial information is an executable software element, for example, itself a hyperlink to further information or to a script. If the piece of partial information is text information, for example, a word, the property may also describe whether the word is a verb, noun, or adjective.

It is especially advantageous in this case if the piece of partial information is classified, for example, with respect to its property, to a higher-level topic and, in particular, if the piece of partial information is text information, with respect to the semantics of this piece of partial information. The selected piece of partial information is assigned to at least one first class by the classification. Moreover, at least one selectable piece of additional information is assigned to at least one second class. This means that the selectable pieces of additional information are also classified with respect to definable criteria. A similarity may then be determined between the first class and the second class that are assigned to the pieces of additional information. If the determined similarity reaches a definable absolute or relative value, the piece of additional information assigned to this class may then be selected. If multiple pieces of additional information are in the same class, evaluation of the pieces of additional information may be performed with respect to further criteria, in particular, with respect to any existing profile information.

Using this method, it is possible, for example, to select only pieces of additional information that are assigned to the same class as the piece of partial information. If the piece of partial information describes, for example, the term “Fashion” and if selectable pieces of additional information concerning a gentlemen's or ladies' suit exist, both pieces of additional information can be selected based on the term “Fashion” because of their high level of similarity with that term. If it is ascertained from the profile assigned to the user that the user is a man, the piece of additional information concerning the product “Gentlemen's suit” is selected. This shows that, in particular, by taking multiple criteria into account both in selection of the piece of partial information and in selection of the piece of additional information, an especially high level of relevance can be achieved, while ensuring that ideally no irrelevant pieces of additional information are transmitted across the communication network.

Preferably, the means of activation is activated by movement of a pointing device assigned to the client, for example, a so-called computer mouse, a touchpad, a keyboard or a touchscreen, in or over a zone assigned to the piece of partial information. A zone assigned to the piece of partial information can be identified, for example, by a colored and/or bordered text or one or more lines or one or more columns. If the pointing device or a graphical pointing element assigned to the pointing device is moved over this zone, the action, for example, display of the piece of additional information or requesting of the piece of additional information can be performed automatically.

In particular, the means of activation can also be activated by operating a switch. The switch can, for example, be a mechanical switch that is disposed on the pointing device. It is also possible for the switch to be displayed as a graphical element on a display device of the client. The switch can be a so-called “button”, which is represented within the information or in a special zone of a software element, for example, the browser.

In particular, a combination of these activation types can be advantageous. For example, by a movement of the pointing device over the zone assigned to the piece of partial information, a reference to the type or topic of the piece of additional information can be displayed. By operating a switch, the actual piece of additional information can be displayed or requested.

The piece of additional information may, for example, itself be nothing more than a link to a further piece of information so that the piece of additional information is, for example, a URL assigned to the further piece of information. The activation element in this case would be, for example, a zone assigned to the piece of partial information. If this is traveled over, for example, by a pointing device or pointing element assigned to the client, the action could be defined in such a way that the piece of additional information, that is, the URL, is displayed in the form of a link that can also be reactivated.

Advantageously, an identifier assigned to the user or the client is entered and, depending on the identifier, the profile assigned to the user or the client is automatically determined. In this case, the identifier can be transmitted across the communication network, for example, to a separate profile server. The profile server selects the profile matching the identifier and transmits this or a certain piece of profile information from it to the server. Of course, the profile server can only be implemented as a software element that is assigned to the server.

Preferably, the identifier is formed from a registration identifier, a credit card number, an EC card number, a string stored in a cookie, a dial-in identifier, a device number or a software number. Such means make it possible to identify the client and/or the user automatically and therefore to select the profile assigned to the user or the client.

For example, if the server provides information for a fee, the user or client must identify itself, for example, by transmitting an identifier and a password. If the server is, for example, an online shop with which the user places an order, the user can be identified by means of the credit card number or the EC card number.

It is especially advantageous if the identifier is stored in a cookie. A cookie is the term for a string that is stored in a storage area assigned to the client. A cookie can, for example, have been transmitted by the server to the client at an earlier time, for example, during registration. This is known as “setting cookies”. A cookie may be set automatically if the client activates a link displayed on a network page or requests a network page from the server. If the client again requests a network page or another type of information from the server, the cookie may be transmitted together with the request from the client to the server. This allows the server to ascertain the identity of the client or of the user on each query.

A device number may, for example, be the serial number of the client or a network card assigned to the client. A software identifier may, for example, be a serial number of the browser or a registration number of a software product installed on the client.

Such identifiers can be analyzed by the server automatically particularly well, so that the profile assigned to the client or the user is identifiable.

Preferably the profile contains at least one piece of profile information about
a property of requested or transmitted information,
an ordered or purchased product,
a product not purchased,
the purchasing behavior of the user,
a field of interest,
an item of personal data assigned to the user,
a search term that was transmitted from the user, the client or another client assigned to the user to a search engine or a product search engine or
a response by the user or by a client assigned to the user with respect to a piece of additional information.

In particular, it is, of course, advantageous if the profile includes numerous pieces of information of this type.

One property of requested or transmitted information, for example, of a network page or of a data stream, can, for example, describe the type of implemented information or the content. Depending on this, pieces of partial information and/or pieces of additional information can be selected that are assigned to similar subject areas or can be assigned to similar types of information. If the information has been transmitted, for example, by means of a data stream and if this data stream implements a feature film of a certain genre, a piece of partial information can be initially selected. A piece of additional information can then be selected that describes movies of the same genre or with the same actors that will appear in the future. If a profile shows that the user buys many books, a review of a book with background information on this feature film or the genre can be offered to the user.

If the piece of additional information is, for example, a piece of product information, a piece of profile information that describes an ordered or purchased product can be used to avoid offering such products to the user again. Similarly, a piece of profile information concerning a product not purchased can be used to offer a comparable product.

Profile information on the purchasing behavior of the user in a shop or in an online shop can, for example, provide information about whether the user prefers especially high-priced products, frequently purchases products of a certain product class, for example, books or fashion articles, shops at certain times of the day/times of year, or about the payment history of the user.

A piece of profile information that describes at least one search term can represent an especially clear interest of the user. In this way, both the pieces of partial information that the user will very probably notice and the especially relevant pieces of additional information can be selected.

A piece of profile information concerning a data item assigned to the user, for example, the age, gender, place of residence, profession, hobbies or other interests, is especially useful for selecting relevant pieces of partial information and additional information.

A piece of profile information concerning the behavior of the user with respect to a piece of additional information displayed to the user can, for example, indicate whether and how often the user really notices a piece of additional information offered to him or her for a piece of partial information on activation of the activation element. From this it is possible to infer whether or not the piece of additional information was relevant to the user.

The profile is advantageously administered by a profile server and includes at least one piece of profile information that was entered by an interaction of the client or of a further client assigned to the user with at least one further server. This increases the number of pieces of profile information because profile information can be entered independently of the client, which is currently being used by the user.

It also means that the pieces of profile information can be entered independently of the server. In this way, an especially up-to-date profile and therefore a piece of additional information of especially great relevance can be achieved. In this case, the profile server can, of course, be implemented in hardware or in software.

Advantageously, a response by the user or the client to the piece of additional information is automatically entered and analyzed and, depending on a result of this analysis, the piece of additional information is automatically evaluated and/or the profile is updated. This permits continual improvement of the inventive method because adaptation to the behavior of the user is possible. If, for example, a user seldom or never takes notice of the pieces of additional information offered to him or her, which can be detected, for example, because the user seldom or never activates the activation elements, it is possible to have no pieces of additional information or only such pieces of additional information displayed that with especially high probability will be very relevant to the user.

In an especially advantageous embodiment of the inventive method, the display element is selected or formed depending on at least one piece of profile information, a property of the piece of additional information, a property of the piece of partial information, or a criterion that can be defined by means of the client. In this case, it is especially advantageous if the display element is selected or formed depending on multiple criteria of this nature.

This permits especially flexible display of the activation element assigned to the piece of partial information or the piece of additional information.

In principle, the display element can be automatically formed, for example, by combining individual, definable components or the display element can be automatically selected from a defined set of display elements. If, in this case, a property of the piece of additional information is taken into account and if this property describes, for example, a type of the piece of additional information or a thematic generic term, the activation element and/or the piece of partial information can be displayed in such a way that this property is already recognizable by the way it is shown.

If the activation element is, for example, a link and if the piece of additional information is a piece of product information, the piece of partial information may be displayed in blue text. But if the piece of additional information is background information, for example, an entry from an online encyclopedia, the piece of partial information can be displayed in green text and underlined. If the piece of additional information is a topical news item, the piece of partial information can be displayed in red bold text. Of course, all further parameters can be displayed instead of the text color, text size, or font depending on such properties. If the activation element is a button, for example, the position, shape, size or labeling can be adapted.

In particular, a property of the piece of partial information can be taken into account in such a way that this property is especially easily recognized. Here, too, the property can, for example, be a certain subject area providing a probability that the piece of partial information and therefore also the piece of additional information assigned to the piece of partial information will be noticed by the user.

It is also especially advantageous if the display element is selected or generated depending on a piece of profile information. This enables, for example, display to depend on a possible level of relevance, for example, because activation elements for pieces of additional information or pieces of partial information from subject areas that are classified as especially relevant to the user are especially conspicuously displayed, for example, by their color, shape, or positioning.

It may also be possible for the client to define which display element will be selected or generated generally—for example always a certain color, size, or position—or which display element will be selected or generated for a certain property of the piece of additional information or the piece of partial information—for example certain color and position for news.

The object is also achieved by a client-server system of the type stated in the introduction, wherein the client-server system provides means for performing the inventive method.

In this case the client-server system advantageously comprises a profile server for administration of at least one profile. This permits, for example, pieces of profile information to be entered in the same profile by different servers.

The client-server system advantageously comprises an additional information server, on which the pieces of additional information can be selected. This enables, for example, multiple different servers to access the same set of pieces of additional information so that an especially large selection of pieces of additional information is available, ensuring an especially high level of relevance of pieces of additional information transmitted to the client or the user.

Implementation of this invention in the form of a computer program is especially advantageous. The computer program is executable on at least one computing device or computer, in particular, on a client or a server and is programmed to execute the inventive method. In particular, for execution of the inventive method, parts of the computer program can run on different computers, in particular, on different clients and different servers. The invention is therefore implemented by the computer program in such a way that this computer program represents the invention in the same way as the method for whose execution the computer program is suitable.

The computer program is preferably stored on a storage element. A storage element can, in particular, be a random-access memory, a read-only memory or a flash memory.

Further characteristics, applications and advantages of the invention can be seen from the following description of examples of the invention that are shown in the drawing. All characteristics described or shown constitute the invention singly or in any combination, irrespective of whether they are summarized in the claims or parts referred to by the claims and irrespective of their wording or representation in the description or in the drawing.

The illustrations show:

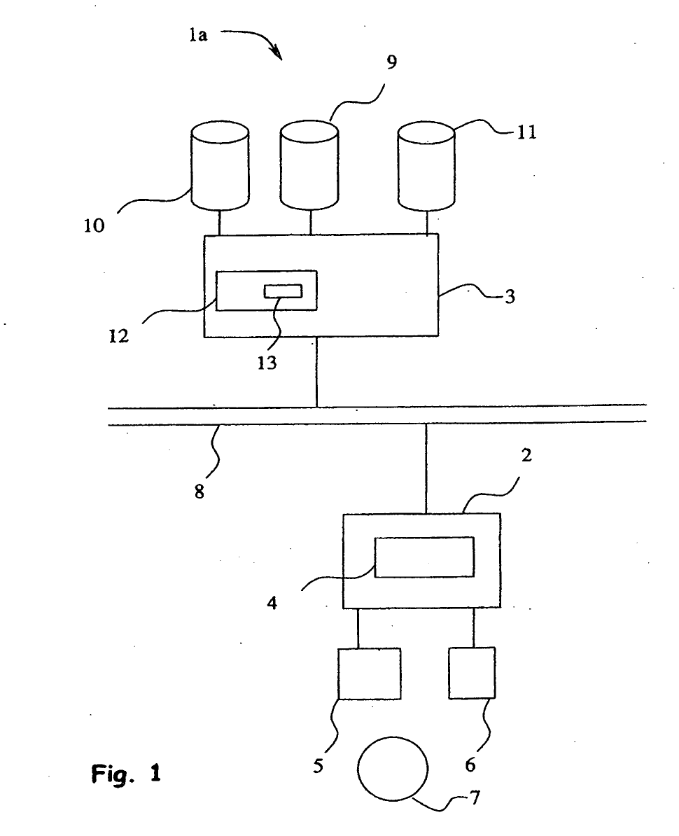

FIG. 1 a client-server system according to a first embodiment;

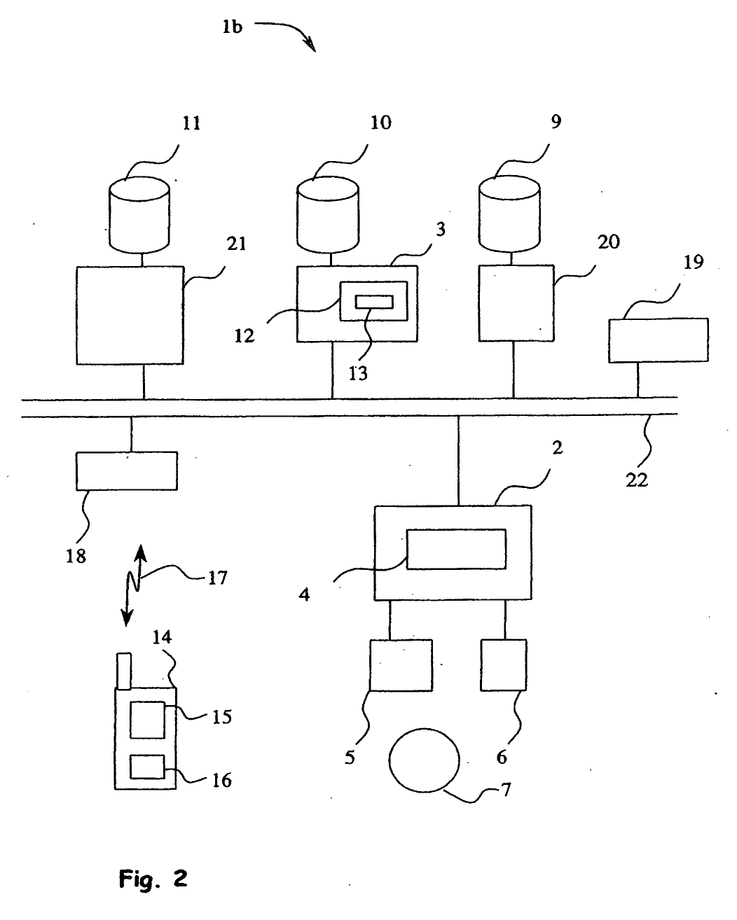

FIG. 2 a client-server system according to a second embodiment and

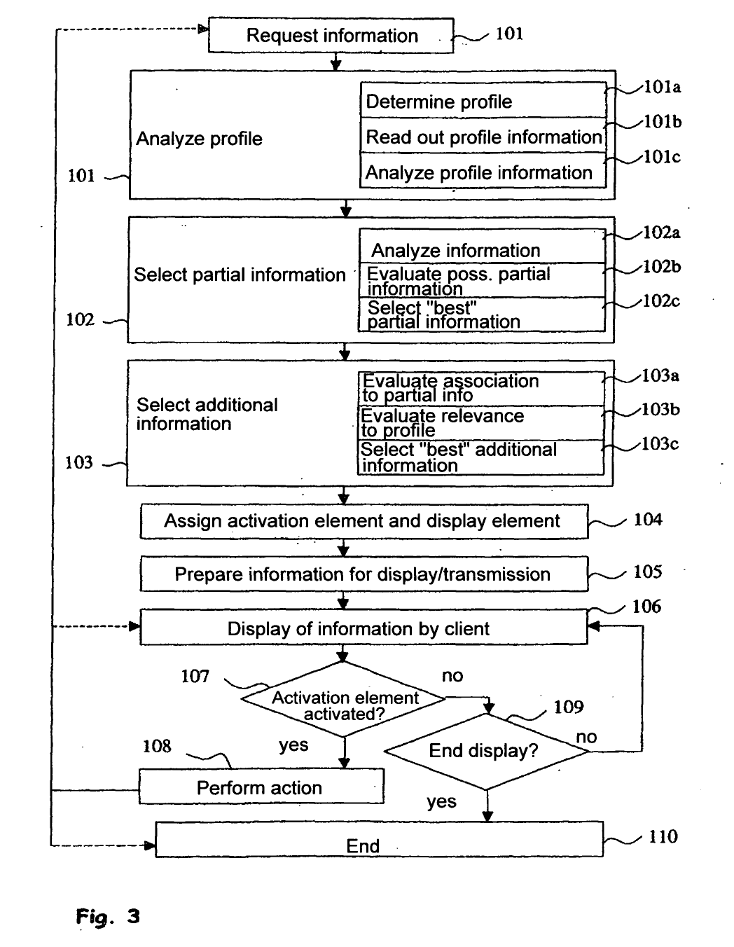

FIG. 3 a flow chart of the inventive method according to a preferred embodiment.

FIG. 1 shows a client-server system 1a that comprises a client 2 and a server 3. A first software element 4, for example, a browser, is installed on the client 2. A display 5 and a pointing device 6 are also assigned to the client 2 that permit a user 7 to interact with the client 2.

The client 2 and the server 3 are connected to a communication network 8. The communication network 8 is, for example, the Internet, a mobile phone network, or a WLAN (wireless local area network).

A profile database 9, an information database 10, and an additional information database 11 are assigned to server 3. On the information database 10, for example, information is stored that can be transmitted from the server 3 to the client 2 in the form of a network page. In particular, network pages already generated can be stored in the information database 10. The information database 10 can also contain data streams, such as video clips or music files.

In the profile database 9, profiles of multiple clients or multiple users 7 are stored. Each profile contains one or more pieces of profile information by means of which possible interests of each user 7 or client 2 can be inferred.

In the additional information database 11, possible pieces of additional information are stored. One or more of these properties characterizing additional information can be stored for each piece of additional information.

A second software element 13 in which the inventive method is implemented is stored in a storage area assigned to server 3 of a software element 12. It is, in particular, possible that a third software element is installed on the client in which a part of the inventive method, for example, the functionality of selection of the display element, is implemented, so that the inventive method would be implemented by interaction of the second software element 13 and the third software element. If the updating element is implemented by the first software element, for example, by the browser, the inventive method can be implemented by execution of the appropriately programmed first software element 4, of the appropriately programmed second software element 13 and of the appropriately programmed third software element. Of course, the inventive method can be broken down into numerous other components that, for example, implement individual functions and these stored and/or executed on further components of a client-server system comprising these components, in particular, of a communication network.

FIG. 2 shows a second embodiment of a client-server system 1b. In this case, components of the client-server system 1b, corresponding to components of the client-server system 1a shown in FIG. 1 are provided with the same reference signs.

The client-server system 1b has a client 2 assigned to a user 7, on which the first software element 4, for example, a browser, is running. The client 2 can, for example, be constituted as a personal computer or as a PDA (personal digital assistant). A further client constituted, for example, as a smartphone 14 is also assigned to the user 7. The smartphone 14 has a display 15 and a keyboard 16. A mobile phone network 17 permits communication of the smartphone 14 with a service provider 18.

The client-server system 1b also has a search engine 19, a server 3, a profile server 20 and an additional information server 21. An information database 10 is assigned to the server 3; a profile database 9, to the profile server 20; and an additional information database 11, to the additional information server 21. The client 2, the service provider 18, the search engine 19, the server 3, the profile server 20, and the additional information server 21 are connected to a communication network constituted as Internet 22. For execution of the inventive method, in addition to the first software element 4 and the software element 13, software elements that implement the individual functionalities of the inventive method when they are run can be stored, in particular, on the profile server 20 and the additional information server 21. For example, selection of the profile can be performed by profile server 20 and selection of the piece of additional information by the additional information server 21.

FIG. 3 shows a possible embodiment of the inventive method schematically in the form of a flow chart.

The method begins in a step 100, during which information is requested from the server 3 by means of the client 2. This can, for example, be done by entering a URL assigned to a network page stored on the server 3. It is also possible to request information from server 3 by means of the client 2 by activating a hyperlink or link that is displayed on a network page already transmitted to the client 2.

In a step 101, a profile assigned to the user 7 or to the client 2 is analyzed. In a sub-step 101a, a query is first made to the profile database 9. For this purpose, an identifier assigned to client 2 or to user 7 is transmitted to the profile database 9. Such an identifier can, for example, be obtained from a cookie that was automatically transmitted from the client 2 to the server 3 in step 100 as the information was requested. It is also possible that, on the request for information from the client 2, a software identifier assigned to it, for example, a serial number or hardware identifier, for example, the serial number of a network card, an IP number assigned to the client 2, or an identifier automatically generated by the browser 4, may be automatically transmitted to the server 3.

Depending on the identifier, a profile assigned to the user or to the client assigned to the user is selected and transmitted to the server 3 from the profile database 9 or the profile server 20.

The profile database 9 can be directly connected to the server 3 as shown in FIG. 1. However, it is also possible, as shown in FIG. 2, for the profile database 9 to be accessible through a profile server 20. In particular, the set of profiles is possibly not stored in one profile database 9 but, for example, in multiple profile databases 9 and, in particular, distributed across multiple profile servers 20. The server 3 can automatically transmit the identifier to all profile servers 20. The profile server 20 that has a matching profile in this case can then, for example, transmit to server 3 over the Internet 22.

In a sub-step 101b, at least one piece of profile information is read out of the selected profile. Such profile information can, for example, be personal data such as age, gender, place of residence, profession or another piece of information, from which an interest of the user 7 can be inferred. Such profile information can, for example, describe products that the user 7 placed in a shopping basket at an online shop but did not purchase. A piece of profile information can, for example, also refer to a certain sector to which products are assigned that were searched for in a product search engine by the user 7. A piece of profile information can also be a search term that the user 7 has transmitted by means of the client 2 to a search engine, for example, the search engine 19.

At least one piece of profile information is analyzed in a sub-step 101c. The existing pieces of profile information, for example, are sorted into different categories, wherein a weighting that is proportional to its relevance is assigned to each category. For example, products searched for in a product search engine are assigned greater relevance than a subject area that describes the thematic focus of an online newspaper subscribed to by the user 7.

Artificial intelligence methods, such as ruled-based expert systems, are used, for example, for selection of the pieces of profile information.

In particular, a set of properties is determined in step 101c that can be used to determine a level of relevance for the user 7 of a piece of partial information.

In a step 102, a piece of partial information is selected from the information. In a sub-step 102a, the information requested by the client 2 is analyzed. If this information is text information, for example, it is first possible to determine by means of a syntactic analysis which strings are suitable as possible pieces of partial information. This could, in particular, be individual words. By means of a semantic analysis it is then possible to determine the content of the possible pieces of partial information.

If the information is, for example, a data stream representing a feature film, the data stream can be examined for certain positions at which, for example, a certain product is displayed or at which certain contents are played.

In a sub-step 102b, the possible pieces of partial information are analyzed. In this case, properties of the possible pieces of partial information, for example, a word class—noun, predicate, adjective—a content, a position within the information displayed or to be displayed, or a font are determined and, based on definable criteria, it is automatically decided which properties are especially suitable in principle as a piece of partial information—for example, the position within the information—, which pieces of partial information will very probably be noticed by the user and which pieces of partial information are especially relevant for the user. In particular, properties can be assigned to the possible pieces of partial information in such a way that by analysis of these properties that, for example, can be weighted, an ordering relationship can be mapped onto the set of possible pieces of partial information. The ordering relationship can be constituted such that a piece of partial information is selected if a high numeric value is assigned to it and possibly in this way a high level of probable relevance can be achieved for this piece of additional information to be assigned to a piece of partial information.

Out of the set of possible pieces of partial information, one or more pieces of partial information are selected in a sub-step 102c, to which pieces of additional information relevant for the user 7 can be assigned with high probability. For example, a piece of partial information can be selected if it has an especially high thematic similarity with an especially highly valued category of the profile. If the information can be displayed, for example, as text on a network page, pieces of partial information can be selected that represent a generic term for a subject area that appears relevant to the user 7 based on the analysis of the assigned profile.

In a step 103, a piece of additional information is selected for the selected piece of partial information. For this purpose, for example, a query is sent to the additional information server 21. Together with the query, the piece of partial information or a description of the piece of partial information is transmitted to the additional information server 21.

In a sub-step 103a, the server 3 or the additional information server 21 checks which pieces of additional information stored in the additional information database 11, for example, can be associated with the piece of partial information or the description of the piece of partial information. For example, the pieces of partial information are classified and a piece of additional information is selected if it is in the same class as the piece of partial information. That means that the possible pieces of additional information are at least implicitly analyzed for the level of association.

It is especially advantageous if a piece of additional information is analyzed depending on an analysis of the profile. Therefore, in a sub-step 103b, a relevance level of one or more possible pieces of additional information is analyzed with respect to the profile.

In this way, a possible relevance level can be increased again. For example, it is feasible for a piece of information on a product that the user 7 has already purchased no longer to be displayed although the user 7 is still very interested in a subject area to which the purchased product belongs.

In a step 104, an activation element and a display element are assigned to the piece of partial information. For example, this may involve making a link, which contains the URL of a network page, on which the piece of additional information is stored, and assigning the link to the piece of partial information in such a way that activation of this link causes a request for this network page. In this case, the activation element is therefore the link. The action assigned to the activation element is to request the network page containing the piece of additional information and the display element can, for example, have the piece of partial information displayed in a certain color and underlined, so that the presence of a link to a piece of additional information is recognizable.

An activation element can, for example, upon moving the pointing device 6 over a zone that, for example, is determined by the graphical display of the piece of partial information in the browser 4, have a piece of information shown in a zone of the browser 4 intended for this purpose that itself displays the piece of additional information, represents a link to the piece of additional information, or displays a short description of the piece of additional information. Display elements can, for example, be coloring of the pieces of partial information.

If the piece of partial information is a string, for example, a word, the piece of partial information can, for example, be displayed in italics, bold typeface or in a different or larger font. If the piece of partial information is part of a data stream, a button can be displayed that can be activated by means of the pointing device 6. The button can, for example, contain a short description of the piece of additional information that can be requested or displayed by activation of the button.

In this case, the display element can, in particular, also be selected or generated depending on a property of the piece of additional information, for example, a subject area, a type of underlying data—video, audio, text—, a type of the piece of additional information—news, product information, technical information or availability—or a possible relevance level for the user. In this case, too, a property of the piece of partial information can also be taken into account, for example, a subject area, a type of the piece of partial information—text or image—or a position within the represented information.

Moreover, the profile can be used again, for example, to determine a display mode preferred by the user or possibly to signal a high or especially low level of relevance for the user already by the way it is displayed. Furthermore, a piece of information can be stored on the client, for example, indicating which display mode the user prefers. This can, in particular, also be differentiated in such a way that it can be seen that a certain display mode of the activation element is preferred for a certain type of additional information.

It is possible, in particular, that by activation of an activation element, the piece of additional information may be transmitted to another client assigned to the user 7, for example, the smartphone 14 and be represented by this. For example, it is possible that on viewing a video film or an Internet TV program, the presence of a piece of additional information is displayed at a certain position. The user 7 can then, by activating the displayed activation element, for example, a button, request the piece of additional information, which is then transmitted from the server 3 to the smartphone 14.

In a step 105, the information is prepared and transmitted to the client 2. For this purpose, the display elements, for example, are included in the information in such a way that the presence of a piece of additional information can be recognized when the pieces of partial information are displayed.

In a step 106, the information is displayed to the user. This can, for example, be done by means of the first software element 4, for example, a browser. If, by means of the browser, a section of the information is displayed that contains a piece of partial information, this will be displayed according to the activation element and the display element.

In a step 107, a check is made to see whether the user is activating an activation element assigned to the piece of partial information.

If this is the case, the associated action will be executed in a step 108. This can, for example, be display of an already transmitted piece of additional information. In particular, if the piece of additional information includes a large volume of data, the action may initially cause the piece of additional information to be requested, for example, from the additional information server 21. This piece of information is then transmitted from the additional information server 21 to the client 2 and displayed to the user 7 by means of the browser.

If the piece of additional information is, for example, only displayed, the method can be continued in step 106 until, for example, a further activation element assigned to a piece of partial information is activated.

In a step 109, a check is made to see whether the display of the information is to be ended, for example, because the browser is deactivated or information is requested by another server and the inventive method cannot be performed with information of this server, for example, because no software element 13 is installed on this server and/or because the operator of this server does not wish the inventive method to be executed.

The method then ends in step 110.

The pieces of additional information themselves can be seen as pieces of information to which the inventive method can be applied. This means that, when the pieces of additional information are requested or transmitted, pieces of partial information are searched for within the pieces of additional information and further pieces of additional information are assigned to these. The inventive method is therefore, in particular, suitable for recursive execution with respect to the request for pieces of additional information, if these are also seen as pieces of information. This is indicated, for example, in FIG. 3, by the fact that it is possible to branch from step 108 back to step 100.

Numerous further embodiments and variants of the embodiment of the method shown in FIG. 3 can be envisioned. For example, individual steps or sub-steps may be omitted or further refinements added.

For example, the method can also be executed without step 103b. Moreover, numerous techniques known to specialists, for example, from the field of “information retrieval” can be applied to select the most meaningful possible profile information or to establish an association between a possible piece of partial information and a possible piece of additional information and then to select the pair piece of partial information—piece of additional information containing the highest evaluation based on definable criteria and, for example, which has the highest probability of an especially high level of relevance and/or the highest probability that the user will feel supported and not disturbed by the piece of additional information.

It is also possible after step 103 to check whether a piece of additional information has been found at all or whether it has sufficient possible relevance. If this is not the case, it is possible to branch back to step 102 and select another piece of partial information. Step 103 is then executed again and a piece of additional information is then selected for this piece of partial information.

It is also possible for a piece of additional information to be initially selected, for example, depending on the profile. If a piece of additional information with an especially high level of relevance is found, it is then possible to search within the pieces of information for a piece of partial information that has the greatest possible association with the piece of additional information found. If no such piece of partial information is found, another piece of additional information can be selected and again a search made for a matching piece of partial information. This means therefore that, for example, steps 102 and 103 can also be executed in reverse order.

It is also possible to start the method by sending an e-mail to the client 2 via an e-mail server. The e-mail can, for example, be automatically generated by the e-mail server or written by another user by means of a client assigned to him or her. In this case, in step 101 the e-mail server will determine and analyze a profile assigned to the recipient of the e-mail, for example, to the user 7. In this case, the e-mail address of the user 7 can be used, for example, as the identifier. The e-mail is then prepared in step 105 by appropriate marking of the pieces of partial information and sent to the client 2.

1-20. (canceled)

21. A method for selection and display of at least one piece of additional information depending on information to be transferred or already transferred from a server to a client across a communication network, the method comprising the steps of:
a) automatically analyzing a profile assigned to the client or a profile assigned to a user of the client;
b) automatically selecting at least one piece of partial information from the information in dependence on the results of step a);
c) automatically selecting the piece of additional information from a definable set of pieces of additional information in dependence on analysis of at least one property of the piece of partial information;
d) automatically assigning an activation element to the piece of partial information, wherein an action assigned to the piece of additional information is performed automatically in response to activation of the activation element;
e) automatically assigning a display element to the activation element by means of which at least one parameter can be defined with respect to display of the activation element on the client; and
f) displaying the activation element on the client.

22. The method of claim 21, wherein the display element describes a property of the display of the piece of partial information.

23. The method of claim 21, wherein the information is transmitted across the communication network or over the Internet in the form of an electronic mail message, an electronic short message service message, a network page, or a data stream.

24. The method of claim 21, wherein the piece of additional information is transferred to the client when the activation element is activated.

25. The method of claim 21, wherein:
selection of the piece of partial information is performed using a means of selection assigned to the server and the information is transmitted to the client together with the activation element; or
the information is transmitted to the client, the piece of partial information is selected on the client, a property of the selected piece of partial information is transmitted to an additional information server, a piece of additional information is selected by the additional information server, the piece of additional information or at least the availability of a piece of additional information is transmitted to the client, and the activation element is displayed on the client.

26. The method of claim 21, wherein the activation element or the display element on the server is assigned to the piece of partial information or the activation element or the display element on the client is assigned to the piece of partial information.

27. The method of claim 21, wherein the piece of partial information is selected in dependence on:
at least one property of at least one possible piece of additional information;
a position within the information; or
a property of the information or a property of a subset of the information within which the piece of partial information is located.

28. The method of claim 21, wherein the piece of additional information is selected in dependence on:
an analysis of the profile;
an evaluation of the piece of additional information available to be selected;
a property assigned to the information, wherein the property describes a content, a subject area, an origin, or a degree of topicality; or
an external condition, wherein the external condition describes a current date, a current time of day, a current location of the user, a current location of the client, a temperature, a current trend, or current events.

29. The method of claim 21, wherein the piece of partial information is assigned to a first class, at least one selectable piece of additional information is assigned to at least one second class, and at least one piece of additional information is selected if there is a definable similarity between the first class and the second class, wherein the first class and the second class are not necessarily different.

30. The method of claim 21, wherein the means of activation is activated by means of movement of a pointing device assigned to the client in or over a zone assigned to the piece of partial information for the purpose of display and/or by means of operation of a switch assigned to the piece of partial information.

31. The method of claim 21, wherein an identifier assigned to the user or the client is entered and, depending on the identifier, the profile assigned to the user or the client is automatically determined, wherein the identifier is constituted by a registration identifier, by a credit card number, by an EC card number, by a string stored in a cookie, by a dial-in identifier, by a device number, or by a software identifier.

32. The method of claim 21, wherein the profile contains at least one piece of profile information with respect to:
a property of requested or transmitted information;
an ordered or purchased product;
a product not purchased;
the purchasing behavior of the user;
a field of interest;
an item of personal data assigned to the user;
a search term that was transmitted from the user, the client or another client assigned to the user to a search engine or to a product search engine; or
a response by the user or by a client assigned to the user with respect to a piece of additional information.

33. The method of claim 21, wherein the profile is administered by a profile server and comprises at least one piece of profile information that was entered by an interaction of the client or of a further client assigned to the user with at least one further server.

34. The method of claim 21, wherein a response of the user or of the client with respect to the piece of additional information is automatically entered and analyzed and depending on a result of this analysis:
the piece of additional information is automatically evaluated; or
the profile is automatically updated.

35. The method of claim 21, wherein the display element is selected or formed depending on at least one piece of profile information, one property of the piece of additional information, one property of the piece of partial information, or one criterion definable by means of the client.

36. A client-server system comprising a client assigned to a user and connectable to a communication network and a server connectable to the communication network, wherein the client-server system comprises means for performing the method of claim 21.

37. The client-server system of claim 36, wherein the client-server system comprises a profile server for administration of at least one profile.

38. The client-server system of claim 36, wherein the client-server system comprises an additional information server and selection of the piece of additional information can be performed on the additional information server.

39. A computer program that is executable on a client-server system, wherein the method of claim 21 is performed when the computer program runs on that client-server system.

40. The computer program of claim 39, wherein the computer program is stored on a storage element, the storage element being constituted as a read-only memory (ROM), a random-access memory (RAM), a hard disk, a compact disk (CD), a digital versatile disk (DVD) or at least one storage area assigned to at least one component of the client-server system.
